(19) United States
(12) Patent Application Publication
(10) Pub. No.: US 2004/0025427 A1
(43) Pub. Date: Feb. 12, 2004

(54) Tree and plant feeder

(76) Inventor: Mercedes L. Walker Brynton, Santa Monica, CA (US)

Correspondence Address: J.D. Harriman II, COUDERT BROTHERS LLP, 23rd Floor, 333 South Hope Street, Los Angeles, CA, 90071, US

(21) Appl. No.: 10/600,823

(22) Filed: Jun. 20, 2003

Related U.S. Application Data
(60) Provisional application No. 60/391,449, filed on Jun. 24, 2002.

(51) Int. Cl. A01G 29/00

(52) U.S. Cl. 47/48.5

(57) ABSTRACT

The invention is an apparatus and method for irrigating a tree or plant with fluids. The apparatus comprises of a pipe whose one end is attached to one end of an on/off stopper. The other end of the stopper is attached to the bottom of a cylindrical shaped section of a container. The container also includes a wedge shaped section with a slot running along one edge. The container and pipe are attached to the tree or plant using two or more attaching devices, which could be double sided Velcro® strips or plastic ties looped through the slot. The pipe could be a transparent bendable plastic pipe, an opaque rigid plastic pipe, or a bendable plastic pipe within a pipe made of a plurality of rigid pieces that telescope within each other. The pipe, stopper, and container can be made of plastic, PVC, metal, or similar material.

### CROSS-REFERENCE TO RELATED APPLICATIONS

The present application claims the benefit of priority from pending U.S. Provisional Patent Application No. 60/391,449, entitled Tree-feeder, filed on Jun. 24, 2002, which is herein incorporated by reference in its entirety.

### BACKGROUND OF THE INVENTION

1. Field of the Invention

The present invention relates to watering trees and plants, and in particular to an apparatus and method for irrigating an indoor tree or plant with water, fertilizers or nutrients mixed in water, or other plain or homogenized fluids.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Many people have at least one indoor tree or plant in their home or office. This tree or plant may be potted, or may be a cut tree, for example, a pine variety during the Christmas season that is locked in place within a special stand. Even though watering a potted tree or plant is not usually a daily chore, watering a cut pine tree during the Christmas season is sometimes done more than once in order to keep the tree looking fresh and to avoid fire hazards. In any case, watering a tree whether cut or potted, or plant can be back breaking and could end with a spillage on the floor due to the location of the foliage, the width of the tree at the base, or any obstructions such as Christmas gifts or the traditional skirting cloth that is used to cover the stand holding the cut tree.

There have been prior art methods to solve the problem of spillage and bending low to the ground when watering a tree or plant, but none of them use a combination of simple components that can be changed to suit the kind of tree or plant giving rise to many embodiments without departing from the scope of the invention. What is needed is a manual system similar to a timer drip system commonly seen to automatically water outdoor plants and trees where a timer controls the beginning and end of a watering cycle connected to a main water line. Since tapping into a main water line within a house or office is not always possible and moreover a network of drip pipes linking one pot to another could be an eye soar, the conventional automatic outdoor drip system is not a practical solution to water all kinds of indoor trees and plants.

### SUMMARY OF THE INVENTION

The embodiments of the present invention provide an apparatus and a method for irrigating an indoor tree or plant with water, fertilizers or nutrients mixed in water, or other plain or homogenized fluids. According to one embodiment of the present invention, the apparatus consists of a cylindrical shaped container, an on/off stopper, a hose-pipe, and three or more attaching devices. According to another embodiment of the present invention, the cylindrical shaped container has a wedge shaped section on one side of the container. This wedge shaped section runs along the entire length (height) of the container and has a slit at the outer edge through which two or more attaching devices can be looped to attach the container to the trunk or other portion of a tree or plant. According to another embodiment of the present invention, the container along with the wedge shaped section are made of plastic, PVC, metal, or any other suitable material. According to another embodiment of the present invention, there is a nipple shaped attachment, usually in the center of the bottom of the container, that accommodates one kind of hose-pipe. According to another embodiment of the present invention, the on/off stopper is attached to the bottom of the container replacing the nipple shaped attachment to accommodate another kind of hose-pipe. According to another embodiment of the present invention, the length of the hose-pipe depends on the size of the tree or plant and the location of the container from the floor. In one embodiment of the present invention, this pipe is attached to one end of the nipple shaped attachment, while the other end of the nipple shaped attachment is attached to the bottom of the container. In another embodiment of the present invention, this pipe is attached to one end of the on/off stopper while the other end of the on/off stopper is attached to the container.

According to another embodiment of the present invention, the hose-pipe is a narrow pipe made of transparent bendable plastic or PVC similar to an ivy-drip pipe. According to another embodiment of the present invention, the hose-pipe is a standard ½″ or ¾″ water line pipe made of opaque rigid PVC. In this embodiment, pieces of the rigid PVC pipes are joint using different angled elbows depending on the shape and size of the tree or plant to which the pipe is to be attached. According to another embodiment of the present invention, the hose-pipe is made up of several individual joints that can telescope within each other to make the pipe longer or shorter in length. In this embodiment, the ivy-drip pipe is inserted within the telescopic pipe, and the number of joints that make up the pipe depend again on the shape and size of the plant or tree to which the pipe is attached. According to another embodiment of the present invention, the attaching devices are double sided Velcro® strips. The number of strips depend on the length of the hose-pipe, but at least three strips are needed to securely attach the container and hose-pipe to the tree or plant, and the length of each strip depends on the thickness of the tree or plant. According to another embodiment of the present invention, the attaching devices are commercially available plastic ties that have a locking mechanism at one end through which the other end is pulled after wrapping it around the item to be securely fastened. Again the number of ties depend on the length of the hose-pipe, but at least three ties are needed to securely attach the container and hose-pipe to the tree or plant, and the length of each tie depends on the thickness of the tree or plant.

### BRIEF DESCRIPTION OF THE DRAWINGS

These and other features, aspects and advantages of the present invention will become better understood with regard to the following description, appended claims and accompanying drawings where:

FIG. 1 illustrates a view of the container with the wedge shaped section according to one embodiment of the present invention.

FIG. 2 illustrates a view of the on/off stopper, according to an embodiment of the present invention.

FIG. 3 illustrates different embodiments of the pipe.

FIG. 4 illustrates an entire apparatus and a method of attaching it to a tree according to one embodiment of the present invention.

FIG. 5 illustrates an entire apparatus and a method of attaching it to a tree according to another embodiment of the present invention.

FIG. 6 illustrates an entire apparatus and a method of attaching it to a tree according to another embodiment of the present invention.

### DETAILED DESCRIPTION OF THE INVENTION

The embodiments of the present invention are an apparatus and a method for irrigating an indoor tree or plant with water, fertilizers or nutrients mixed in water, or other plain or homogenized fluids. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

According to one embodiment of the present invention, the apparatus consists of a cylindrical shaped container with a wedge shaped section attached to one side, an on/off stopper, a hose-pipe, and three or more attaching devices. Each of these components are explained in further detail below.

Cylindrical Container

The cylindrical container has a wedge shaped extension attached to one side of the container running along the entire height of the container. This wedge shaped section is a solid piece that has a slit running along its outer edge through which two or more attaching devices are looped to securely attach the container to the tree or plant. According to another embodiment of the present invention, the wedge shaped section is of different heights depending on the height of the container. For example, the wedge is 5^{½}″ or 6^{¼}″ in height. It should be noted here that these heights are merely for descriptive purposes and other heights are equally possible without departing from the scope of the invention. According to another embodiment of the present invention, the wedge shaped section makes different angles with the side of the container. For example, the wedge makes a 65° or 70° angle with the side of the container. Again, it should be noted here that these angels are merely for descriptive purposes and other angles are equally possible without departing from the scope of the invention.

According to one embodiment of the present invention, the cylindrical shaped container holds different amounts of fluid in its “belly”. One size of container can hold, for example, 10.6 fluid ounces of fluid. Another size can hold 21.2 fluid ounces of fluid. It should be noted here that these capacities are merely for descriptive purposes and other capacities are equally possible depending on the size of the tree or plant and the amount of water or other fluids it needs to grow and flourish without departing from the scope of the invention.

In operation, fluid is poured from the top end of the container, which is always kept open for easy access. Gravity assists in filling the container to the top and also in discharging the fluid from the container down the hose-pipe. The bottom end is closed except for an opening, usually in the center of the bottom end. According to one embodiment of the present invention, a nipple shaped attachment is plugged in the opening so that a hose-pipe can be attached to its exposed end. In this embodiment, the hose-pipe is similar to an ivy-drip transparent bendable plastic or PVC pipe. According to another embodiment of the present invention, an on/off plug is plugged in the opening, which is kept in the “off” position while the fluid is filled from the other end. The exposed end of the on/off plug accommodates a hose-pipe, which in this embodiment is a standard ½ or ¾ water line pipe made of opaque rigid PVC.

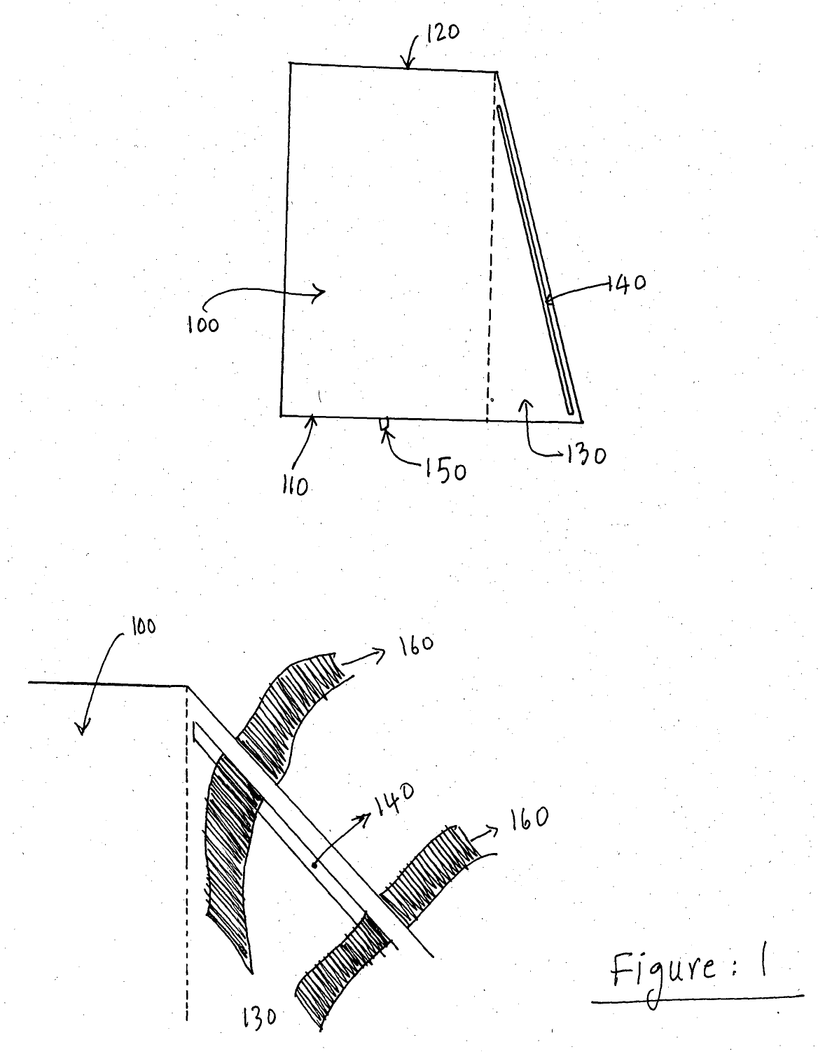

According to another embodiment of the present invention, the container along with the nipple shaped attachment or the on/off stopper, and the wedge shaped section are all made of rigid plastic or PVC, metal, or any other suitable material. FIG. 1 illustrates one embodiment of the container with the attached slotted wedge shaped section on the side and nipple on the bottom. Container 100 has a bottom end 110 and a top end 120. Wedge shaped section 130 is attached to one side of the container so that its top edge makes an angle with the side of the container (marked “X°”) such that when an attaching device is looped through slot 140 to hang the container, the container hangs at an angle. Bottom end 110 has an opening in the center which is plugged with nipple 150. This nipple, as explained above, accommodates an ivy-drip hose-pipe (not shown) at its exposed end. The figure also shows a magnified view of wedge shaped section 130 with attaching devices 160 looped through slot 140.

On/Off Stopper

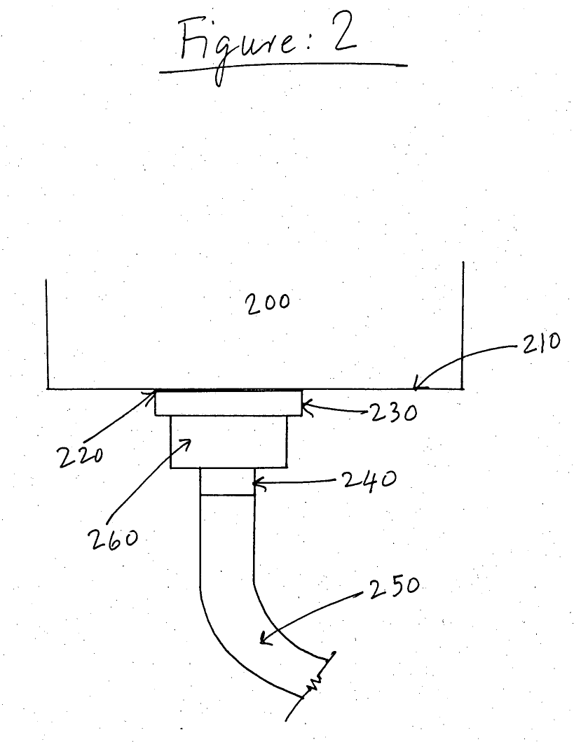

According to one embodiment of the present invention, one end of the on/off stopper is attached to the opening in the bottom end of the cylindrical container and the other end is attached to one end of the hose-pipe. FIG. 2 illustrates a kind of on/off stopper. Stopper 230 has end 220 attached to the opening in the bottom end 210 of a container 200, and end 240 attached to one end of a hose-pipe 250. The stopper has a valve 260 that can be pulled vertically down or pushed vertical up to respectively start or stop the flow of fluid from the container down the pipe. In operation, when the container is being filled with a fluid, valve 260 is pushed vertically up (the “off” position). Once the user is ready to discharge the fluid from the container down the hose-pipe, the user pushes the valve vertically down (the “on” position). The force of the fluid down the hose-pipe can be further controlled by adjusting the valve in a position between pushing it vertically all the way up and pulling it vertically all the way down. According to another embodiment of the present invention, the on/off stopper is made of rigid plastic or PVC, metal, or any other suitable material. According to another embodiment of the present invention, the size of the stopper as well as the size of pipe it can accommodate depends on the size of pipe, and the amount of fluid that needs to be discharged per second (rate of flow).

Hose-Pipe

According to one embodiment of the present invention, the hose-pipe is a narrow pipe made of transparent, bendable plastic or PVC. This narrow pipe can be 7/16″ or 9/16″ in diameter. According to another embodiment of the present invention, the hose-pipe is a standard ½″ or ¾″ water pipe made of opaque rigid PVC. According to another embodiment of the present invention, the hose-pipe is made up of an outer pipe and an inner pipe. The outer pipe is made of several rigid pieces of plastic or PVC that fit within each other and the inner pipe is a narrow transparent bendable plastic or PVC pipe that is attached to the nipple shaped attachment at the bottom of the container. In operation, the rigid pieces that make the outer pipe are telescoped to increase or decrease the length of the pipe. Once the correct length is accomplished, the inner bendable pipe is cut to size.

Plastic and PVC are just two illustrations of the materials that the hose-pipe can be made of, but it must be noted here that other materials such as copper can be used without departing from the scope of the invention. According to another embodiment of the present invention, the length of the hose-pipe depends on the height of the tree or plant and also on the distance from the ground that the container is attached to the tree or plant.

According to another embodiment of the present invention, one end of the pipe is attached to the exposed end of the on/off stopper that is attached-to the bottom end of the container. The other end of the pipe is left just above the soil level in the case of a potted tree or plant, or just inside the container in the case of a cut tree. When the bendable pipe is used, it is wrapped around the trunk of the tree or around branches and stems of a plant. If the rigid pipe is used then the pipe can be in several pieces joined by elbows of varying degrees (45°, 60°, or 90°) depending on the shape and size of the tree or plant. If the telescoping rigid pipe is used, the user can cut the inner pipe to the desired length depending on the size and shape of the tree or plant.

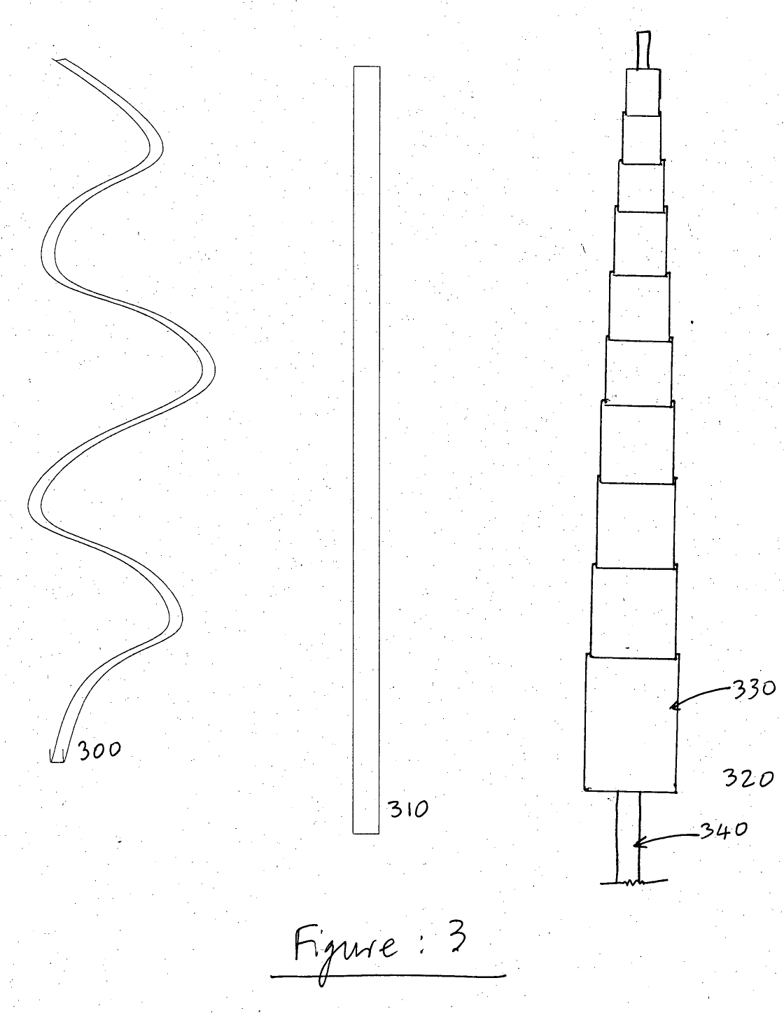

FIG. 3 illustrates the three versions of the pipes mentioned above. Pipe 300 is the bendable transparent pipe similar to an ivy-drip pipe. Pipe 310 is a standard ½″ or ¾″ water pipe made of plastic, PVC, or metal. Pipe 320 is the rigid telescoping pipe comprising of two layers. Pipe 320 is made up of outer layer 330 comprising of several rigid pieces of plastic or PVC that can telescope within each other to increase or decrease the length of the pipe. Pipe 320 has a bendable transparent pipe 340 within outer layer 330. As explained above, once the desired length of pipe is accomplished, a user can cut the inner bendable pipe to size before attaching the inner bendable pipe to the nipple shaped attached at the bottom of the container.

Attaching Devices

The apparatus has at least three attaching devices to fix the container along with the pipe to the tree or plant. Two of these are needed to attach the container, and at least one is needed to attach the loose end of the adjoining pipe. According to one embodiment of the present invention, the attaching devices are double sided Velcro® strips. According to another embodiment of the present invention, the attaching devices are commercially available plastic ties that have a locking mechanism at one end through which the other end is pulled after wrapping it around the item to be securely fastened. The number of strips or ties depends on the length of the tree or plant or conversely on the length of the pipe, but at least three are needed to securely fasten the container along with the pipe to the tree or plant. The length of each strip and tie also depends on the thickness of the tree truck or branch around which the container and pipe is fastened.

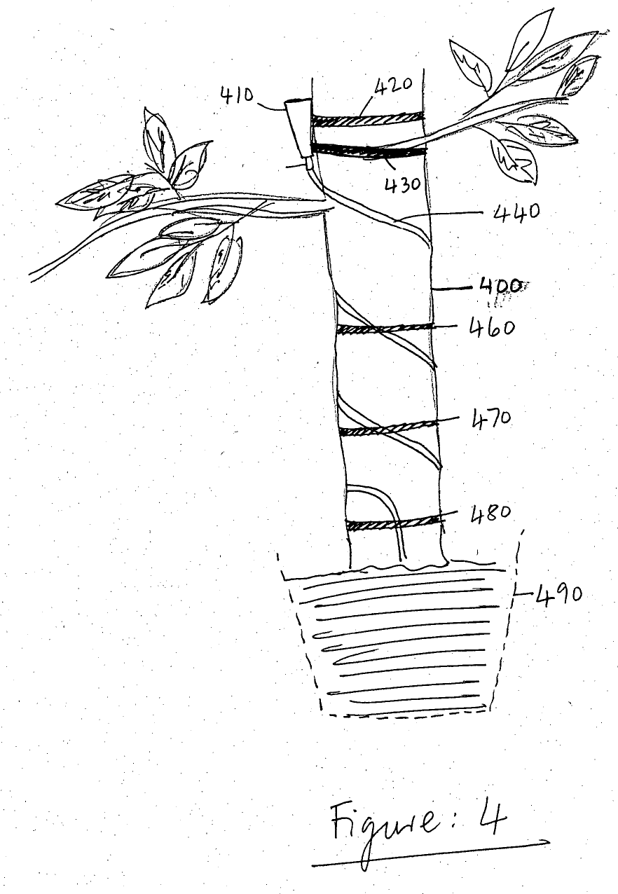

FIG. 4 illustrates an apparatus and a method of attaching the apparatus according to one embodiment of the present invention. In this illustration a bendable plastic pipe and double sided Velcro® strips are used. Tree 400 has container 410 securely fixed with strips 420 and 430 looped through the slot in the wedge shaped section (not shown). One end of pipe 440 is attached to a nipple 450 attached to the bottom end of container 4 1 0. Pipe 440 is then wrapped around the trunk and the other end of the pipe is left just above the soil level in pot 490. Strips 460-480 are wrapped around the pipe at regular intervals to further secure the pipe.

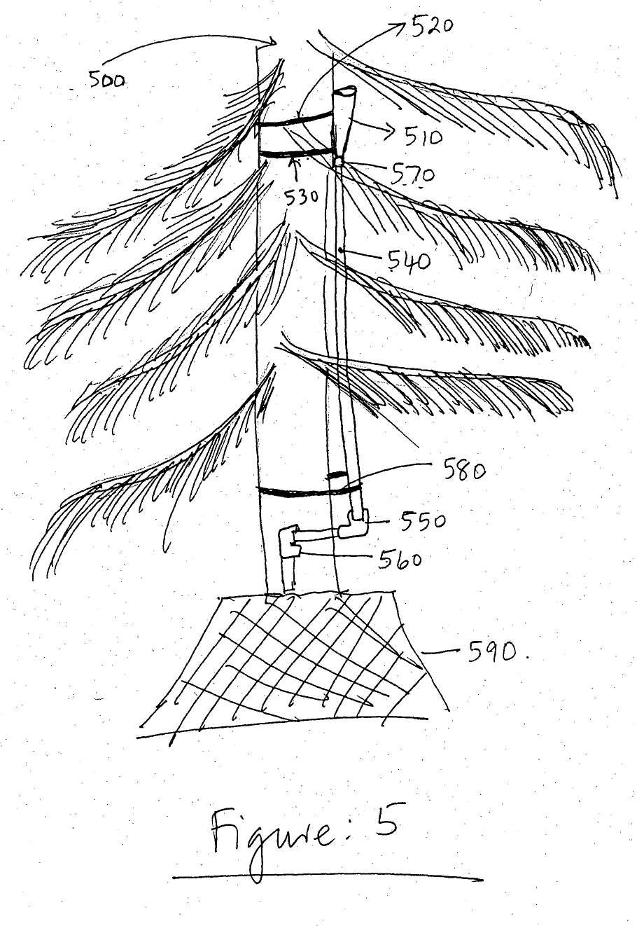

FIG. 5 illustrates an apparatus and a method of attaching the apparatus according to another embodiment of the present invention. In this illustration a rigid PVC pipe and plastic ties are used. Tree 500 has a container 510 securely fastened with ties 520 and 530 looped through the slot in the wedge shaped section (not shown). Since pipe 540 is rigid, it is broken up into several pieces (3 in the figure) and fixed together using elbows 550 and 560 of varying degrees. The topmost end of the pipe is attached to an on/off stopper 570 attached to the bottom end of container 510. Pipe 540 is tied using tie 580 and the bottom-most end of the pipe is left just above the soil level in pot 590.

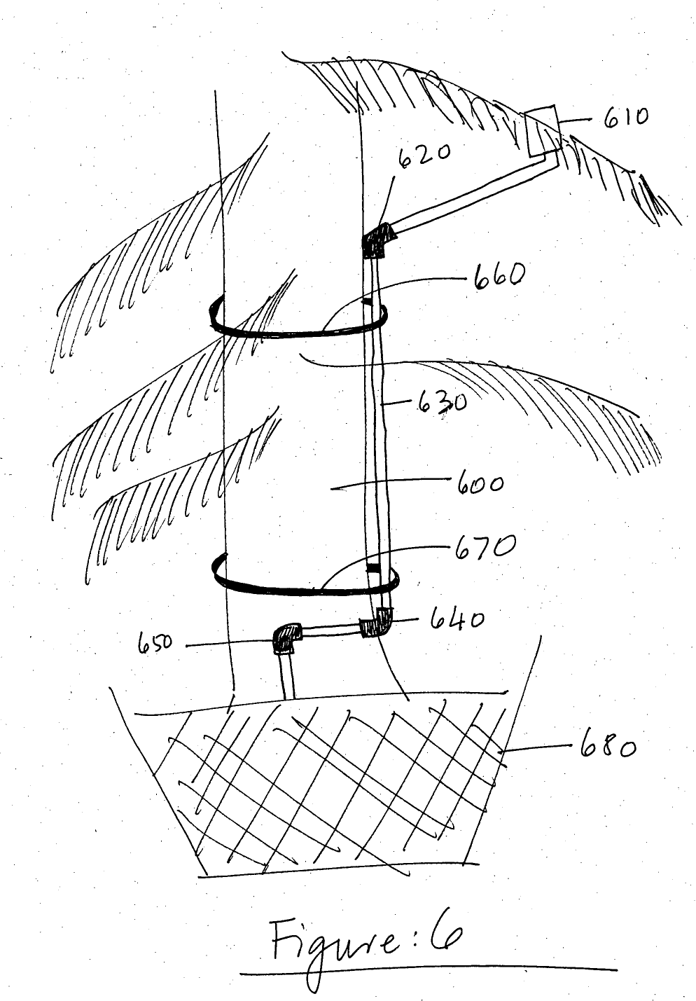

FIG. 6 illustrates an apparatus and a method of attaching the apparatus according to another embodiment of the present invention. In this illustration, a rigid PVC pipe and plastic ties are used. Tree 600 has a container 610 that can be swung around elbow 620. Since pipe 630 is rigid, it is broken up into several pieces (5 in the figure) and fixed together using elbows 620, 640, and 650 of varying degrees. The pipe is tied in two places using ties 660 and 670 to secure the apparatus around tree 600. The bottom end of the pipe is left just above the soil level in pot 680.

Thus, an apparatus and a method for irrigating an indoor tree or plant with water, fertilizers or nutrients mixed in water, or other plain or homogenized fluids is described in conjunction with one or more specific embodiments. The invention is defined by the following claims and their full scope of equivalents.

I claim:

1. A tree or plant feeder comprising:
a container;
an on/off stopper with two ends, one end of which is attached to a bottom end of said container;
a pipe whose one end is attached to an end of said on/off stopper different from end attached to said container; and
three or more attaching devices for attaching said container and said pipe to a tree or a plant.

2. The feeder of claim 1 wherein said container further comprising:
a cylindrical shaped section with an open top end and a closed bottom end; and
a wedge shaped solid section attached to one side of said cylindrical shaped section such that the vertical height of said wedge is the same as the vertical height of said cylindrical shaped section.

3. The feeder of claim 2 wherein said cylindrical shaped section has a capacity of 10.6 fluid oz.

4. The feeder of claim 3 wherein said cylindrical shaped section has a capacity of 21.2 fluid oz.

5. The feeder of claim 2 wherein said wedge shaped section has a slot running the height of said wedge along an angled edge opposite to edge of said wedge attached to said cylindrical shaped section of said container.

6. The feeder of claim 5 wherein said angled edge makes an angle of 65° with said side of cylindrical section attached to said wedge.

7. The feeder of claim 6 wherein said angled edge makes an angle of 70° with said side of cylindrical section attached to said wedge.

8. The feeder of claim 1 wherein at least two of said three or more attaching devices are looped through said slot to attach said container to said tree or plant.

9. The feeder of claim 1 wherein said container, said on/off stopper, and said pipe are made of plastic.

10. The feeder of claim 9 wherein said container, said on/off stopper, and said pipe are made of PVC.

11. The feeder of claim 9 wherein said container, said on/off stopper, and said pipe are made of metal.

12. The feeder of claim 2 wherein said cylindrical shaped section and said wedge shaped section of said container are made of plastic.

13. The feeder of claim 12 wherein said cylindrical shaped section and said wedge shaped section of said container are made of PVC.

14. The feeder of claim 12 wherein said cylindrical shaped section and said wedge shaped section of said container are made of metal.

15. The feeder of claim 1 wherein said pipe is of a length equal to at least the height of said container from bottom of said tree or plant.

16. The feeder of claim 1 wherein said pipe is made of transparent bendable plastic.

17. The feeder of claim 16 wherein said pipe is made of transparent bendable PVC.

18. The feeder of claim 1 wherein said pipe is made of opaque rigid plastic.

19. The feeder of claim 18 wherein said pipe is made of opaque rigid PVC.

20. The feeder of claim 1 wherein said pipe further comprising:
an outer pipe made of a plurality of opaque rigid plastic pieces that telescope within each other; and
a pipe within said outer pipe made of transparent bendable plastic.

21. The feeder of claim 20 wherein said outer pipe is made of a plurality of opaque rigid PVC pieces that telescope within each other.

22. The feeder of claim 1 wherein said pipe is a plurality of opaque rigid plastic pipes joint together by a plurality of opaque rigid plastic elbows.

23. The feeder of claim 22 wherein said pipe is a plurality of opaque rigid PVC pipes joint together by a plurality of opaque rigid PVC elbows.

24. The feeder of claims 22 or 23 wherein said elbows have a 45°, 60°, or 90° angle.

25. The feeder of claim 1 wherein said attaching devices are double sided Velcro® strips.

26. The feeder of claim 25 wherein said strips have lengths equal to at least the thickness of said tree or plant to which they are attached.

27. The feeder of claim 1 wherein said attaching devices are plastic ties.

28. The feeder of claim 27 wherein said ties have lengths equal to at least the thickness of said tree or plant to which they are attached.

29. The feeder of claim 1 wherein at least one of said three or more attaching devices are used to attach said pipe to said tree or plant.

30. A method of attaching a feeder to a tree or plant, comprising:
attaching a first end of a pipe to a first end of an on/off stopper;
attaching a second end of said stopper different from said first end of said stopper to a bottom end of a container;
attaching at least two attaching devices through a slot on said container to attach said container to said tree or plant; and
attaching one or more attaching devices around said pipe to attach said pipe to said tree or plant.

31. The method of attaching said feeder to said tree or plant of claim 30 such that said container further comprises:
a cylindrical shaped section with an open end and a closed end; and
a wedge shaped solid section attached to one side of said cylindrical shaped section such that the vertical height of said wedge is the same as the vertical height of said cylindrical shaped section.

32. The method of attaching said feeder to said tree or plant of claim 31 such that the cylindrical shaped section has a capacity of 10.6 fluid oz.

33. The method of attaching said feeder to said tree or plant of claim 32 such that the cylindrical shaped section has a capacity of 21.2 fluid oz.

34. The method of attaching said feeder to said tree or plant of claim 31 such that said wedge shaped section has said slot running the height of said wedge along an angled edge opposite to edge of said wedge attached to said cylindrical shaped section of said container.

35. The method of attaching said feeder to said tree or plant of claim 34 such that said angled edge makes an angle of 65° with said side of cylindrical section attached to said wedge.

36. The method of attaching said feeder to said tree or plant of claim 35 such that said angled edge makes an angle of 70° with said side of cylindrical section attached to said wedge.

37. The method of attaching said feeder to said tree or plant of claim 30 such that said container, said on/off stopper, and said pipe are made of plastic.

38. The method of attaching said feeder to said tree or plant of claim 37 such that said container, said on/off stopper, and said pipe are made of PVC.

39. The method of attaching said feeder to said tree or plant of claim 37 such that said container, said on/off stopper, and said pipe are made of metal.

40. The method of attaching said feeder to said tree or plant of claim 31 such that said cylindrical shaped section and said wedge shaped section of said container are made of plastic.

41. The method of attaching said feeder to said tree or plant of claim 40 such that said cylindrical shaped section and said wedge shaped section of said container are made of PVC.

42. The method of attaching said feeder to said tree or plant of claim 40 such that said cylindrical shaped section and said wedge shaped section of said container are made of metal.

43. The method of attaching said feeder to said tree or plant of claim 30 such that said pipe is of a length equal to at least the height of said container from bottom of said tree or plant.

44. The method of attaching said feeder to said tree or plant of claim 30 such that said pipe is made of transparent bendable plastic.

45. The method of attaching said feeder to said tree or plant of claim 44 such that said pipe is made of transparent bendable PVC.

46. The method of attaching said feeder to said tree or plant of claim 30 such that said pipe is made of opaque rigid plastic.

47. The method of attaching said feeder to said tree or plant of claim 46 such that said pipe is made of opaque rigid PVC.

48. The method of attaching said feeder to said tree or plant of claim 30 such that said pipe further comprises:
an outer pipe made of a plurality of opaque rigid plastic pieces that telescope within each other; and
a pipe within said outer pipe made of transparent bendable plastic.

49. The method of attaching said feeder to said tree or plant of claim 48 such that said outer pipe is made of a plurality of opaque rigid PVC pieces that telescope within each other.

50. The method of attaching said feeder to said tree or plant of claim 30 such that said pipe is a plurality of opaque rigid plastic pipes join together by a plurality of opaque rigid plastic elbows.

51. The method of attaching said feeder to said tree or plant of claim 50 such that said pipe is a plurality of opaque rigid PVC pipes join together by a plurality of opaque rigid PVC elbows.

52. The method of attaching said feeder to said tree or plant of claims 50 or 51 such that said elbows have a 45°, 60°, or 90° angle.

53. The method of attaching said feeder to said tree or plant of claim 30 such that said attaching devices are double sided Velcro® strips.

54. The method of attaching said feeder to said tree or plant of claim 53 such that said strips have lengths equal to at least the thickness of said tree or plant to which they are attached.

55. The method of attaching said feeder to said tree or plant of claim 30 such that said attaching devices are plastic ties.

56. The method of attaching said feeder to said tree or plant of claim 53 such that said ties have lengths equal to at least the thickness of said tree or plant to which they are attached.
